(19) United States
(12) Patent Application Publication
(10) Pub. No.: US 2010/0182393 A1
(43) Pub. Date: Jul. 22, 2010

(54) LIGHT SCANNING UNIT AND IMAGE FORMING APPARATUS INCLUDING THE SAME

(75) Inventors: Hee Sung CHO, Suwon-si (KR); Byung Sun Ahn, Suwon-si (KR); Chun Sub Ryu, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/649,445

(22) Filed: Dec. 30, 2009

(30) Foreign Application Priority Data
Jan. 16, 2009 (KR) 2009-3842

(51) Int. Cl. B41J 27/00; G02B 26/08

(52) U.S. Cl. 347/259; 359/205.1

(57) ABSTRACT

A light scanning unit and an image forming apparatus having the same. The light scanning unit to form an electrostatic latent image corresponding to image information on a photosensitive body may include a light source, a deflector to deflect light generated from the light source in a main scanning direction, an imaging lens to focus deflected light to the photosensitive body, and at least a reflection mirror to change a traveling direction of light. A deviation of light quantity generated in a main scanning direction by a light quantity ratio generated by internal absorption of the imaging lens and a light quantity ratio generated by a polarization state of light may be compensated for by the reflection mirror.

### CROSS-REFERENCE TO RELATED APPLICATIONS

This application claims the benefit of Korean Patent Application No. 2009-0003842, filed on Jan. 16, 2009 in the Korean Intellectual Property Office, the disclosure of which is incorporated herein by reference.

### BACKGROUND

1. Field of the Invention

Embodiments of the present general inventive concept relate to a light scanning unit having a low deviation of a light quantity ratio and an image forming apparatus including the same.

2. Description of the Related Art

A light scanning unit is included in an electrophotographic image forming apparatus such as a laser printer, a digital copier, and a multifunctional unit integrating functions thereof. The light scanning unit serves to form an electrostatic latent image on the surface of a photosensitive body by scanning light corresponding to an image signal to the photosensitive body.

The light scanning unit includes a light source, a polygonal mirror to deflect light emitted from the light source in a main scanning direction, and an imaging lens to focus an image onto the photosensitive body.

A general imaging lens includes at least one plastic lens. Typically, as the thickness of an imaging lens increases, quantity of light absorbed by the lens is increased and the transmittance of light transmitted through the lens deteriorates. Accordingly, a variation in the thickness of the imaging lens in a main scanning direction generates a deviation of a quantity ratio of light reaching the photosensitive body.

As the wavelength of the light from the light source decreases, the quantity of light absorbed by the imaging lens of a plastic material increases. In the light scanning unit using the light source generating light having a short wavelength, the deviation of the quantity ratio of light reaching the photosensitive body shows a tendency to increase.

A polarization direction of light generated from the light source is one factor affecting a deviation of a quantity ratio of light reaching the photosensitive body. Specifically, the quantity ratio of light reaching the photosensitive body differs in a main scanning direction according to a ratio of a P polarization component and an S polarization component of light scanned from the light source.

### SUMMARY

The present general inventive concept provides a light scanning unit having a reduced deviation of a light quantity ratio and an image forming apparatus including the same.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a light scanning unit to form an electrostatic latent image corresponding to image information on a photosensitive body including a light source, a deflector to deflect light generated from the light source in a main scanning direction, an imaging lens to focus deflected light to the photosensitive body, and at least a reflection mirror to change a traveling direction of light, wherein a reflectance of the reflection mirror satisfies the following equation:

$$\frac{( - δ - 20 \times Pr )}{100} \leq \frac{( Rs - Rc )}{Rc} \leq \frac{( - δ + 20 - 20 \times Pr )}{100} , \\ where$$

$$δ = \frac{{δ}_{s} - {δ}_{c}}{{δ}_{c }} \times 100 ,$$

Rc is a reflectance of a center of the reflection mirror, Rs is a reflectance of an edge of one side of the reflection mirror, δc is a transmittance of a center of the imaging lens, δs is a transmittance of an edge of one side of the imaging lens, and Pr is a component ratio of a P polarized light based on a deflecting surface of the deflector, and where Pr=1 when only a P polarized light is present based on an incident surface of the deflecting surface of the deflector, and Pr=0 when only an S polarized light is present based on the incident surface of the deflecting surface of the deflector.

A wavelength of light generated from the light source may be less than about 500 nm.

The component ratio Pr may be less than about 0.5.

The reflection mirror may include aluminum, and TiO₂ and SiO₂ coated in the aluminum.

The imaging lens may be a plastic material.

The reflection mirror may be arranged between the deflector and the imaging lens.

The reflection mirror may be arranged between the imaging lens and the photosensitive body.

The foregoing and/or other features and utilities of the present general inventive concept may be achieved by providing an image forming apparatus including a photosensitive body, a light scanning unit to form an electrostatic latent image by irradiating light corresponding to image information onto the photosensitive body, and a developing unit for form a visual image by supplying a developer to the photosensitive body on which the electrostatic latent image is formed, wherein the light scanning unit includes a light source, a deflector to deflect light generated from the light source in a main scanning direction, an imaging lens to focus deflected light to the photosensitive body, and at least a reflection mirror to change a traveling direction of light, and wherein a reflectance of the reflection mirror satisfies the following equation:

$$\frac{( - δ - 20 \times Pr )}{100} \leq \frac{( Rs - Rc )}{Rc} \leq \frac{( - δ + 20 - 20 \times Pr )}{100} , \\ where$$

$$δ = \frac{δ s - δ c}{δ c} \times 100 ,$$

Rc is a reflectance of a center of the reflection mirror, Rs is a reflectance of an edge of one side of the reflection mirror, δc is a transmittance of a center of the imaging lens, δs is a transmittance of an edge of one side of the imaging lens, and Pr is a component ratio of a P polarized light based on a deflecting surface of the deflector, and where Pr=1 when only a P polarized light is present based on an incident surface of the deflecting surface of the deflector, and Pr=0 when only an S polarized light is present based on the incident surface of the deflecting surface of the deflector.

A wavelength of light generated from the light source may be less than about 500 nm.

The component ratio Pr may be less than about 0.5.

The reflection mirror may include aluminum, and TiO₂ and SiO₂ coated in the aluminum.

The imaging lens may be a plastic material.

The reflection mirror may be arranged between the deflector and the imaging lens.

The reflection mirror may be arranged between the imaging lens and the photosensitive body.

The foregoing and/or other features and utilities of the present general inventive concept may be achieved by providing a light scanning unit to form an electrostatic latent image corresponding to image information on a photosensitive body including a light source to generate light having a wavelength less than about 500 nm, a deflector to deflect light generated from the light source in a main scanning direction, an imaging lens of a plastic material to focus deflected light to the photosensitive body, and at least a reflection mirror to change a traveling direction of light, wherein a reflectance of the reflection mirror satisfies the following equation:

$$\frac{( - δ - 20 \times Pr )}{100} \leq \frac{( Rs - Rc )}{Rc} \leq \frac{( - δ + 20 - 20 \times Pr )}{100} , \\ where$$

$$δ = \frac{δ s - δ c}{δ c} \times 100 ,$$

Rc is a reflectance of a center of the reflection mirror, Rs is a reflectance of an edge of one side of the reflection mirror, δc is a transmittance of a center of the imaging lens, δs is a transmittance of an edge of one side of the imaging lens, and Pr is a component ratio of a P polarized light based on a deflecting surface of the deflector, and where Pr=1 when only a P polarized light is present based on an incident surface of the deflecting surface of the deflector, and Pr=0 when only an S polarized light is present based on the incident surface of the deflecting surface of the deflector.

The foregoing and/or other features and utilities of the present general inventive concept may be achieved by providing a light scanning unit to form an electrostatic latent image corresponding to image information on a photosensitive body including a light source, a collimating lens array to collimate light generated from the light source, a reflection mirror to calibrate a deviation of a light quantity, thereby improving the image quality of images produced by the light scanning unit, and an imaging lens to focus reflected light to the photosensitive body.

A wavelength of light generated from the light source may be less than about 500 nm.

A wavelength of light generated from the light source may be greater than about 500 nm.

The reflection mirror may include a plurality of reflection mirrors selected according to the equations:

Rc=Rc1×Rc2× . . . Rcn

Rs=Rs1×Rs2× . . . Rsn

where Rc1, Rc2 . . . , Rcn indicate a reflectance of light reflected from a center of each of the plurality of reflection mirrors and Rs1, Rs2, . . . , Rsn indicate a reflectance of light reflected from one side of each of the plurality of reflection mirrors.

The reflection mirror may be coated with SiO₂ to a thickness of approximately 185 nm on a base material of aluminum and may be further coated with TiO₂ to a thickness of approximately 125 nm thereon.

The reflection mirror may be coated with SiO₂ to a thickness of approximately 145 nm on a base material of aluminum and may be further coated with TiO₂ to a thickness of approximately 213 nm thereon.

The reflection mirror may be coated with SiO₂ to a thickness of between approximately 145 and 185 nm on a base material of aluminum and may be further coated with TiO₂ to a thickness of between approximately 125 and 213 nm thereon, the thicknesses selected to satisfy the following equation:

$$\frac{( - δ - 20 \times Pr )}{100} \leq \frac{( Rs - Rc )}{Rc} \leq \frac{( - δ + 20 - 20 \times Pr )}{100} , \\ where$$

$$δ = \frac{δ s - δ c}{δ c} \times 100 ,$$

Rc indicates a reflectance of light reflected from a center of the reflection mirror, Rs indicates a reflectance of light reflected from an edge of one side of the reflection mirror, δc indicates a transmittance of a center of the imaging lens, δs indicates a transmittance of an edge of one side of the imaging lens, and Pr indicates a component ratio of a polarized light based on a deflecting surface of the deflector.

The foregoing and/or other features and utilities of the present general inventive concept may be achieved by providing an image forming apparatus including a photosensitive body, a light scanning unit to form an electrostatic latent image by irradiating light corresponding to image information onto the photosensitive body, and a developing unit for form a visual image by supplying a developer to the photosensitive body on which the electrostatic latent image is formed. The light scanning unit may include a light source, a collimating lens array to collimate light generated from the light source, a reflection mirror to calibrate a deviation of a light quantity, thereby improving the image quality of images produced by the light scanning unit, and an imaging lens to focus reflected light to the photosensitive body.

A wavelength of light generated from the light source may be less than about 500 nm.

A wavelength of light generated from the light source may be greater than about 500 nm.

The reflection mirror may include a plurality of reflection mirrors selected according to the equations:

Rc=Rc1×Rc2× . . . Rcn

Rs=Rs1×Rs2× . . . Rsn

where Rc1, Rc2 . . . , Rcn indicate a reflectance of light reflected from a center of each of the plurality of reflection mirrors and Rs1, Rs2, . . . , Rsn indicate a reflectance of light reflected from one side of each of the plurality of reflection mirrors.

The reflection mirror may be coated with SiO₂ to a thickness of approximately 185 nm on a base material of aluminum and may be further coated with TiO₂ to a thickness of approximately 125 nm thereon.

The reflection mirror may be coated with SiO₂ to a thickness of approximately 145 nm on a base material of aluminum and may be further coated with TiO₂ to a thickness of approximately 213 nm thereon.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 a cross-sectional diagram illustrating the configuration of an image forming apparatus according to an exemplary embodiment of the present general inventive concept;

FIG. 2 is a perspective view illustrating the configuration of a light scanning unit according to an exemplary embodiment of the present general inventive concept;

FIG. 3 is a graph illustrating an absorption rate of light by a plastic lens according to wavelength;

FIG. 4 is a graph showing transmittance of a lens according to a polarization direction of a light source;

FIG. 5 is a graph showing reflectance of a reflection mirror according to an exemplary embodiment of the present general inventive concept;

FIG. 6 is a graph showing reflectance of a reflection mirror according to another exemplary embodiment of the present general inventive concept; and

FIG. 7 is a perspective view illustrating the configuration of a light scanning unit according to another exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout.

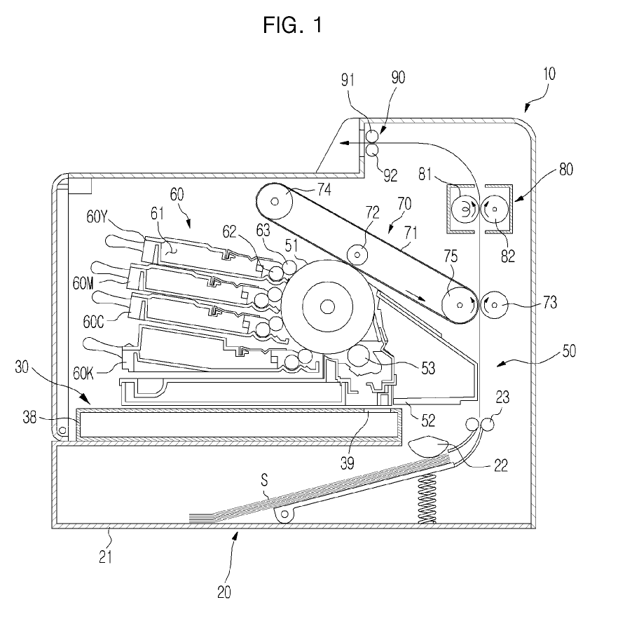

FIG. 1 is a cross-sectional diagram illustrating the configuration of an image forming apparatus according to an exemplary embodiment of the present general inventive concept.

As illustrated in FIG. 1, the image forming apparatus includes a main body 10, a print medium supply unit 20, a light scanning unit 30, a photosensitive body unit 50, a developing unit 60, a transfer unit 70, a fusing unit 80, and a print medium discharge unit 90.

The main body 10 forms the exterior appearance of the image forming apparatus and supports constituent components installed therein.

The print medium supply unit 20 includes a cassette 21 which stores a print medium S, a pickup roller 22 which picks up the print medium S loaded in the cassette 21 sheet by sheet, and a delivery roller 23 which conveys the pick-up print medium S towards the transfer unit 70.

The light scanning unit 30 includes a case 38 having a transparent member 39 to externally irradiate light and includes a scanning optical system installed inside the case 38. The light scanning unit 30 including the scanning optical system will be described in detail later on.

The photosensitive body unit 50 includes a photosensitive body 51, a photosensitive body housing 52, and a charge roller 53. The photosensitive body 51 is rotatably installed in the photosensitive body housing 52 and is charged to a prescribed electric potential by the charge roller 53 before light is scanned thereto from the light scanning unit 30.

The developing unit 60 includes four developing devices 60Y, 60M, 60C, and 60K to contain developers of different colors, for example, yellow (Y), magenta (M), cyan (C), and black (K) and supply the developers to the photosensitive body 51 on which electrostatic latent images are formed.

Each of the developing devices 60Y, 60M, 60C, and 60K includes a developer receiving part 61, a supply roller 62, and a developing roller 63. The developer receiving part 61 contains the developers to be supplied to the photosensitive body 51. The supply roller 62 supplies the developers stored in the developer receiving part 61 to the developing roller 63. The developing roller 63 attaches the developers onto the surface of the photosensitive body 51 on which the electrostatic latent images are formed, thereby forming visible images.

The transfer unit 70 includes an intermediate transfer belt 71, a first transfer roller 72, and a second transfer roller 73. The intermediate transfer belt 71 is supported by support rollers 74 and 75 and travels at the same linear speed as a linear speed of the photosensitive body 51. The first transfer roller 72 faces the photosensitive body 51 with the intermediate transfer belt 71 disposed therebetween and transfers the visible images formed on the photosensitive body 51 to the intermediate transfer belt 71. The second transfer roller 73 faces the support roller 75 with the intermediate transfer belt 71 disposed therebetween. The second transfer roller 73 is separated from the intermediate transfer belt 71 while an image is transferred from the photosensitive body 51 to the intermediate transfer belt 71. If the image of the photosensitive body 51 is completely transferred to the intermediate transfer belt 71, the second transfer roller 73 contacts the intermediate transfer belt 71 with prescribed pressure. If the second transfer roller 73 contacts the intermediate transfer belt 71, the image of the intermediate transfer belt 71 is transferred to a print medium.

The fusing unit 80 includes a heating roller 81 having a heating source and a pressure roller 82 installed to face the heating roller 81. When a print medium passes between the heating roller 81 and the pressure roller 82, an image is fixed to the print medium by heat transmitted from the heating roller 81 and by pressure acting between the heating roller 81 and the pressure roller 82.

The print medium discharge unit 90 includes a discharge roller 91 and a discharge backup roller 92 and discharges the print medium passing through the fusing unit 80 to the exterior of the main body 10.

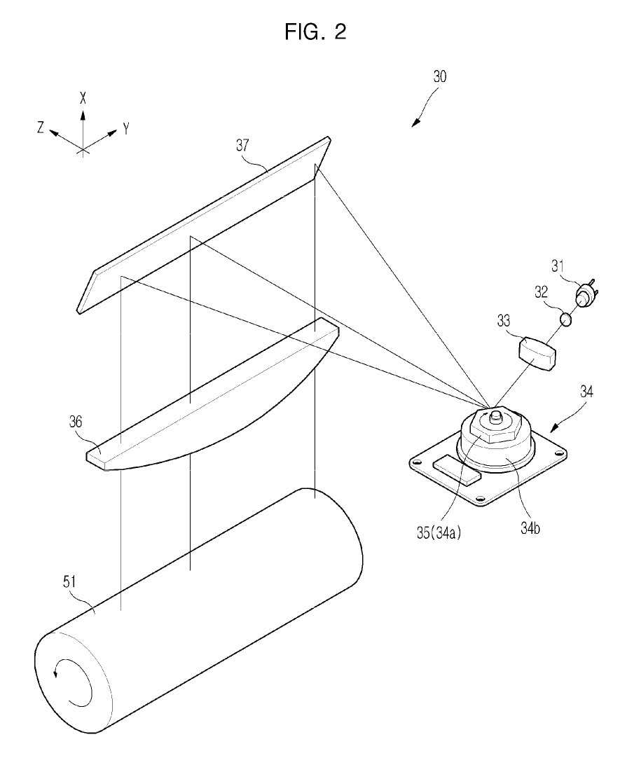

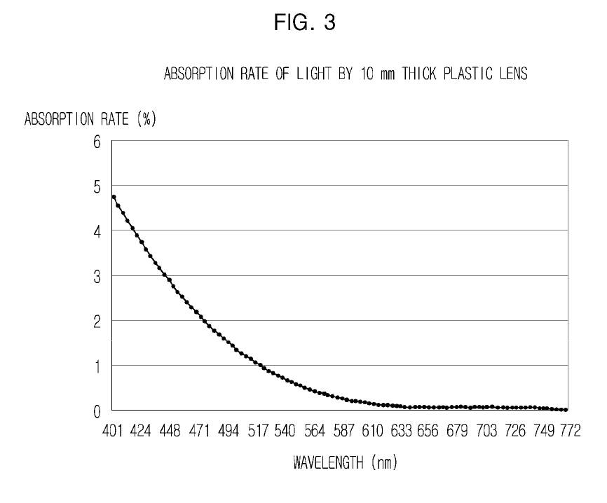

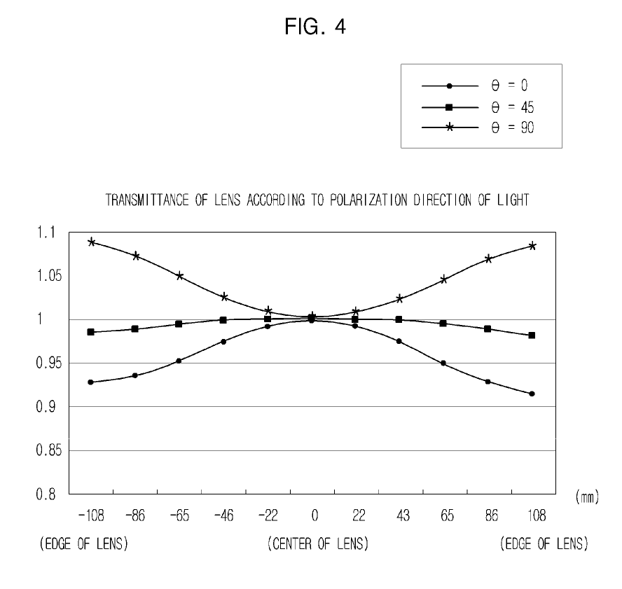

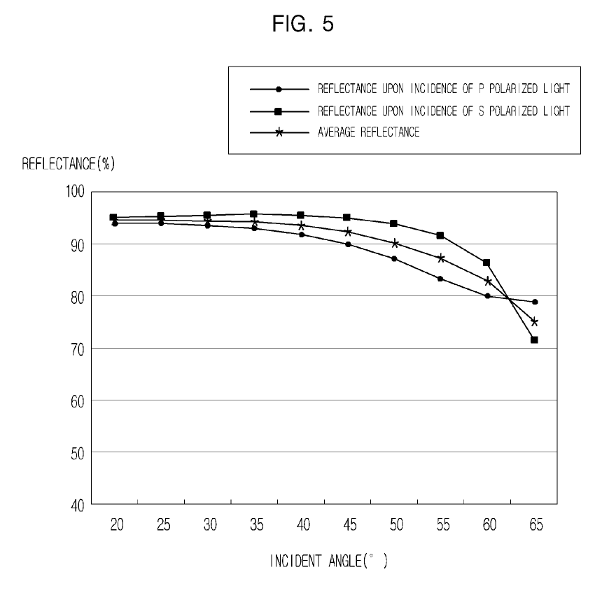

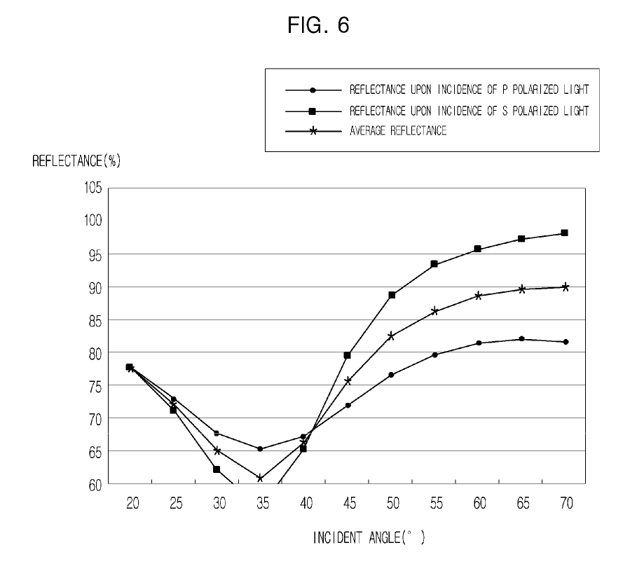

FIG. 2 is a perspective view illustrating the configuration of a light scanning unit according to an exemplary embodiment of the present general inventive concept. FIG. 3 is a graph showing an absorption rate of light by a plastic lens according to wavelength. FIG. 4 is a graph showing transmittance of a lens according to a polarization direction of a light source. FIG. 5 is a graph showing reflectance of a reflection mirror according to an exemplary embodiment of the present general inventive concept. FIG. 6 is a graph showing reflectance of a reflection mirror according to another exemplary embodiment of the present general inventive concept.

As illustrated in FIG. 2, the light scanning unit 30 includes a light source 31, a collimating lens 32, a cylindrical lens 33, a deflector 34, an imaging lens 36, and a reflection mirror 37.

The light source 31 is a laser diode type and generates light having a wavelength less than, for example, 500 nm, thereby easily achieving a high-resolution image.

The collimating lens 32 collimates or condenses light emitted from the light source 31 to convert the light into parallel light or convergent light.

The cylindrical lens 33 condenses the light transmitted through the collimating lens 32 in a direction corresponding to a main scanning direction and/or a sub-scanning direction so that light incident onto the deflector 34 may be linearly focused. The cylindrical lens 33 includes at least one lens.

The deflector 34 deflects light in a main scanning direction Y of the photosensitive body 51 and includes a polygonal mirror 34a having a plurality of deflecting surfaces 35 and a motor 34b to rotate the polygonal mirror 34a.

The imaging lens 36 focuses deflected light onto the photosensitive body 51 and includes, for example, an fθ lens arranged between the deflector 34 and the photosensitive body 51. The imaging lens 36 includes at least one lens and calibrates light deflected from the deflector 34 to different magnifications in a main scanning direction Y and a sub-scanning direction X, thereby forming images on the photosensitive body 51. Although the imaging lens 36 of the exemplary embodiment is one plastic lens, it may include a plurality of plastic lenses.

The reflection mirror 37 changes a traveling direction of light and is arranged between the deflector 34 and the imaging lens 36. The reflection mirror 37 serves to calibrate a deviation of a light quantity generated in the main scanning direction Y according to internal absorption of the imaging lens 36 and a polarization state of light generated from the light source 31.

More specifically, the deviation of the light quantity generated in the main scanning direction Y of light reaching the photosensitive body 51 is greatly affected by a light quantity ratio δ generated by internal absorption of the imaging lens 36 and a light quantity ratio Lv generated by a polarization state of light generated from the light source 31. In this case, the light quantity ratio δ generated by the internal absorption of the imaging lens 36 and the light quantity ratio Lv generated by the polarization state of the light generated from the light source 31 is defined as follows.

$$\begin{matrix}δ = \frac{δ s - δ c}{δ c} \times 100 & [ Equation 1 ] \\ Lv = 20 \times Pr - 10 & [ Equation 2 ]\end{matrix}$$

In Equation 1, δc indicates a transmittance of the center of the imaging lens 36, and δs is a transmittance of the edge of one side of the imaging lens 36. The transmittance δs of one side of the imaging lens 36 indicates a transmittance of a point at which a difference with the transmittance of the center of the imaging lens 36 is maximized. As illustrated in FIG. 3, as the wavelength of light decreases, an absorption rate at the plastic lens of light is increased and the light quantity ratio δ generated by the internal absorption of the imaging lens 36 is increased. FIG. 3 illustrates an absorption rate of light at a plastic lens of light according to a wavelength of a conventional plastic lens having a thickness of about 10 mm.

In relation to Equation 2, if a polarization direction of light is a P polarized light based on an incident surface of a deflected surface, a transmittance of each of both ends of a lens is higher than a center thereof by about 10% due to a difference between reflectances generated at boundaries of the lens as illustrated in FIG. 4. If a polarization direction of light is an S polarized light based on an incident surface of a deflected surface, a transmittance of each of both ends of a lens is lower than a center thereof by about 10% due to a difference of the reflectances generated at the boundaries of the lens. In FIG. 4, θ=0 indicates the S polarized light, θ=90 indicates the P polarized light, and, θ=45 indicates light including 50% of the P polarized light and 50% of the S polarized light. FIG. 4 shows a relative transmittance of light according to a distance from the center of the lens when the transmittance of light passing through the center of the lens is 1.

Equation 2 shows such a relationship as a proportional equation and Pr denotes a component ratio of the P polarized light based on the incident surface of the deflector. For example, if only the P polarized light is present based on the incident surface of the deflected surface of the polarizer, Pr becomes 1, and if only the S polarized light is present based on the incident surface of the polarizer, Pr becomes 0.

A light quantity ratio Π generated from the reflection mirror 37 is defined as follows.

$$Π = \frac{Rs - Rc}{Rc} \times 100 \qquad [ Equation 3 ]$$

In Equation 3, Rc denotes a reflectance of the center of the reflection mirror and Rs denotes a reflectance of the edge of one side of the reflection mirror. The reflectance Rs of one side of the reflection mirror indicates a reflectance of a point at which a reflectance having a maximum deviation as compared with the center of the reflection mirror occurs.

In the light scanning unit 30, the sum of the light quantity ratio δ generated by internal absorption of the imaging lens 36, the light quantity ratio Lv generated by the polarization state of light generated from the light source 31, and the light quantity ratio Π generated from the reflection mirror 37 is controlled to be within ±10%. This may be expressed as follows.

−10≦(δ+Π+Lv)≦10 [Equation 4]

If Lv and Π are eliminated from Equation 4 using Equation 2 and Equation 3, the following reflectance may be obtained.

$$\frac{( - δ - 20 \times Pr )}{100} \leq \frac{( Rs - Rc )}{Rc} \leq \frac{( - δ + 20 - 20 \times Pr )}{100} \qquad [ Equation 5 ]$$

Accordingly, in the light scanning unit of this exemplary embodiment, a deviation of light quantity generated in the main scanning direction Y by the light quantity ratio δ generated by the internal absorption of the imaging lens 36 and the light quantity ratio Lv generated by the polarization state of the light generated from the light source 31 is compensated for by the reflection mirror 37.

For example, when a P polarized light having a wavelength less than 500 nm based on the incident surface of the deflecting surface 35 of the deflector 34 is emitted, a transmittance of the edge of the imaging lens 36 is higher than the center thereof by about 10%. In other words, the light quantity ratio δ generated by the internal absorption of the imaging lens 36 is 10. Since a Pr value of the P polarized light is 1, a relationship of the reflectance of the reflection mirror 37 may be obtained from the Equation 5 as follows.

$$- 0.3 \leq \frac{( Rs - Rc )}{Rc} \leq - 0.1 \qquad [ Equation 6 ]$$

Therefore, when the P polarized light having a wavelength less than 500 nm based on the incident surface of the deflector is emitted, if reflectances of the center of the reflection mirror and the edge of one side thereof are controlled within the range of Equation 6, a deviation of a light quantity in the main scanning direction of light reaching the photosensitive body is maintained within the range of ±10%.

FIG. 5 is a graph illustrating a reflectance of a reflection mirror according to an exemplary embodiment of the present general inventive concept. The reflection mirror of this embodiment includes aluminum, and TiO₂ and SiO₂ coated in the aluminum. More specifically, the reflection mirror is coated with SiO₂ to a thickness of 185 nm on a base material of aluminum and is further coated with TiO₂ to a thickness of 125 nm thereon. As an incident angle is increased, a reflectance of the reflection mirror is decreased (refer to FIG. 3). Since an incident angle at both sides of the imaging lens is larger than an angle at the center of the imaging lens, the reflection mirror satisfies the conditions of Equation 6.

FIG. 6 is a graph showing a reflectance for an incident angle in a reflection mirror that is coated with SiO₂ to a thickness of 145 nm on a base material of aluminum and is further coated with TiO₂ to a thickness of 213 nm thereon. As shown in FIG. 4, a reflectance according to an incident angle may be adjusted by varying a material and coating component of the reflection mirror or varying the thickness of a coating layer.

Meanwhile, when an S polarized light having a wavelength less than 500 nm based on the incident surface of the reflecting surface of the deflector 34 illustrated in FIG. 2 is emitted, a transmittance of the edge of the imaging lens is higher than the center thereof by about 10%. In other words, the light quantity ratio δ generated by the internal absorption of the imaging lens 36 is 10. Since a Pr value of the S polarized light is 0, a relationship of the reflectance of the reflection mirror may be obtained from the Equation 5 as follows.

$$- 0.1 \leq \frac{( Rs - Rc )}{Rc} \leq 0.1 \qquad [ Equation 7 ]$$

Accordingly, when the S polarized light having a wavelength less than 500 nm based on the incident surface of the deflector is emitted, if reflectances of the center of the reflection mirror and the edge of one side thereof are controlled within the range of Equation 6, a deviation of a light quantity in the main scanning direction of light reaching the photosensitive body is maintained within the range of ±10%.

When comparing Equation 6 with Equation 7, it may be appreciated that a reflection mirror is demanded that satisfies the condition that a difference of reflectances between the center of the reflection mirror and the edge of one side of the reflection mirror is significant as the component ratio of the P polarized light is increased. Accordingly, as the component ratio of the P polarized light is decreased, that is, as the component ratio of the S polarized light is increased, manufacture of the reflection mirror satisfying Equation 5 is facilitated. That is, a calibration amount caused by the reflection mirror is increased as the component ratio of the P polarized light is increased, and the number of coating layers of the reflection mirror should be increased as the calibration amount caused by the reflection mirror is increased. In consideration of facilitation of manufacture of the reflection mirror, the component ratio of the P polarized light may be controlled within about 0.5.

As described above, even if light having a short wavelength less than 500 nm, which has an absorption rate that is greatly increased by a plastic lens, is used, since a deviation of light quantity generated in the main scanning direction is compensated for by the reflection mirror, the light scanning unit according to the exemplary embodiments may achieve high resolution and high quality images.

Moreover, high quality images may be achieved since the deviation of the light quantity according to the polarization component of light generated from the light source is calibrated by the reflection mirror.

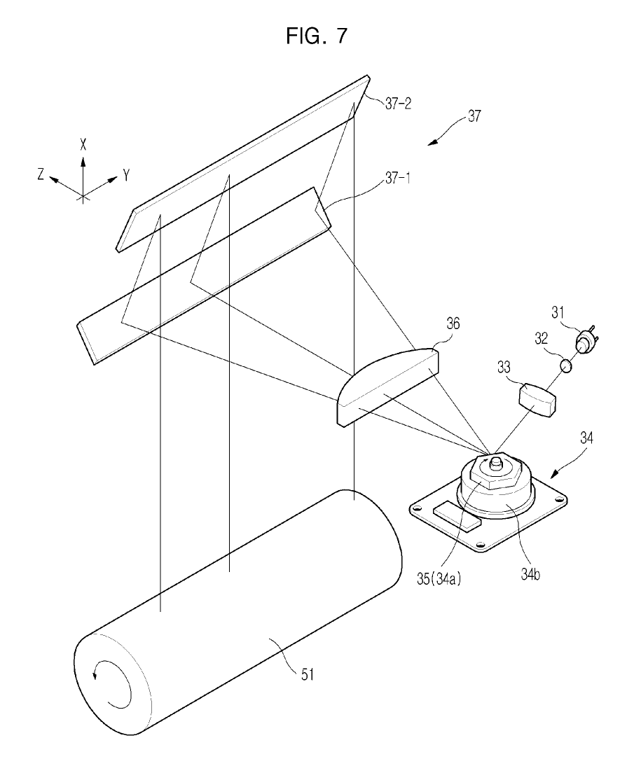

FIG. 7 is a perspective view illustrating the configuration of a light scanning unit according to another exemplary embodiment of the present general inventive concept. A description of the same constituent elements as in FIG. 2 will be omitted and like reference numerals denote like elements.

A reflection mirror 37 according to this embodiment includes a first reflection mirror 37-1 and a second reflection mirror 37-2 and is arranged between an imaging lens 36 and a photosensitive body 51. Reflectances of the reflection mirror 37 are calculated as follows.

Rc=Rc1×Rc2 [Equation 8]

Rs=Rs1×Rs2 [Equation 9]

Rc1 and Rc2 indicate reflectances of light reflected from the center of each of the first reflection mirror 37-1 and the second reflection mirror 37-2, respectively. Rs1 and Rs2 indicate reflectances of light reflected from one side of each of the first reflection mirror 37-1 and the second reflection mirror 37-2, respectively.

Reflectances of the light scanning unit having n reflection mirrors are calculated as follows.

Rc=Rc1×Rc2× . . . Rcn [Equation 10]

Rs=Rs1×Rs2× . . . Rsn [Equation 11]

An operation of an image forming apparatus having such a configuration will now be described in brief. If a print operation is initiated, the charge roller 53 uniformly charges the surface of the photosensitive body 51. Light corresponding to image information of, for example, a yellow color is irradiated from the light scanning unit 30 to the surface of the uniformly charged photosensitive body 51 and an electrostatic latent image corresponding to the yellow image is formed on the photosensitive body 51.

Next, a developing bias voltage is applied to the developing roller 53 of the yellow developing device 60Y and a yellow developer is attached to the electrostatic latent image, thereby forming a yellow visual image on the photosensitive body 51. Such a visual image is transferred to the intermediate transfer belt 71 by the first transfer roller 72.

If transfer corresponding to the amount of one page for the yellow color is completed, the light scanning unit 30 scans light corresponding to image information of another color, for example, magenta to the photosensitive body 51, thereby forming an electrostatic latent image corresponding to a magenta image. The magenta developing device 60M supplies a magenta developer to the electrostatic latent image to form a visual image. The magenta visual image formed on the photosensitive body 51 is transferred to the intermediate transfer belt 71 by the first transfer roller 72. The magenta visual image may overlap the yellow visual image transferred prior to the magenta visual image.

If the above process is implemented for cyan and black colors, a color image overlapping the yellow, magenta, cyan, and black colors is formed on the intermediated transfer belt 71. The color image is transferred onto the print medium S passing between the intermediate transfer belt 71 and the second transfer roller 73 and the print medium S is discharged to the exterior of the main body 10 via the fusing unit 80 and the print medium discharge unit 90.

As is apparent from the above description, a light scanning unit and an image forming apparatus including the same according to the embodiment of the present general inventive concept reduce a deviation of a light quantity ratio.

Although a few embodiments of the present general inventive concept have been shown and described, the light scanning unit may be applied to image forming apparatuses of other forms.

The image forming apparatus of the exemplary embodiment includes one photosensitive body on which visual images of yellow, magenta, cyan, and black colors are formed but the image forming apparatus may include a plurality of photosensitive bodies provided individually in each developing device.

Although the light source generating light having a short wavelength has been used as the light source in the exemplary embodiments, other light sources may be used. For example, a light source generating light having a wavelength greater than 500 nm may be employed.

The number and positions of the reflection mirrors have been exemplarily shown and thus it would be apparent that they are not limited thereto.

Although a few embodiments of the present general inventive concept have been shown and described, it would be appreciated by those skilled in the art that changes may be made in these embodiments without departing from the principles and spirit of the invention, the scope of which is defined in the claims and their equivalents.

What is claimed is:

1. A light scanning unit to form an electrostatic latent image corresponding to image information on a photosensitive body, comprising:
a light source;
a deflector to deflect light generated from the light source in a main scanning direction;
an imaging lens to focus deflected light to the photosensitive body; and
at least a reflection mirror to change a traveling direction of light,
wherein a reflectance of the reflection mirror satisfies the following equation:
$$\frac{( - δ - 20 \times Pr )}{100} \leq \frac{( Rs - Rc )}{Rc} \leq \frac{( - δ + 20 - 20 \times Pr )}{100} , \\ where$$
$$δ = \frac{δ s - δ c}{δ c} \times 100 ,$$
Rc is a reflectance of a center of the reflection mirror, Rs is a reflectance of an edge of one side of the reflection mirror, δc is a transmittance of a center of the imaging lens, δs is a transmittance of an edge of one side of the imaging lens, and Pr is a component ratio of a P polarized light based on a deflecting surface of the deflector, and
where Pr=1 when only a P polarized light is present based on an incident surface of the deflecting surface of the deflector, and Pr=0 when only an S polarized light is present based on the incident surface of the deflecting surface of the deflector.

2. The light scanning unit according to claim 1, wherein a wavelength of light generated from the light source is less than about 500 nm.

3. The light scanning unit according to claim 1, wherein the component ratio Pr is less than about 0.5.

4. The light scanning unit according to claim 1, wherein the reflection mirror includes aluminum, and TiO₂ and SiO₂ coated in the aluminum.

5. The light scanning unit according to claim 1, wherein the imaging lens is a plastic material.

6. The light scanning unit according to claim 1, wherein the reflection mirror is arranged between the deflector and the imaging lens.

7. The light scanning unit according to claim 1 wherein the reflection mirror is arranged between the imaging lens and the photosensitive body.

8. An image forming apparatus comprising:
a photosensitive body;
a light scanning unit to form an electrostatic latent image by irradiating light corresponding to image information onto the photosensitive body; and
a developing unit for form a visual image by supplying a developer to the photosensitive body on which the electrostatic latent image is formed,
wherein the light scanning unit includes a light source, a deflector to deflect light generated from the light source in a main scanning direction, an imaging lens to focus deflected light to the photosensitive body, and at least a reflection mirror to change a traveling direction of light, and
wherein a reflectance of the reflection mirror satisfies the following equation:
$$\frac{( - δ - 20 \times Pr )}{100} \leq \frac{( Rs - Rc )}{Rc} \leq \frac{( - δ + 20 - 20 \times Pr )}{100} , \\ where$$
$$δ = \frac{δ c - δ c}{δ c} \times 100 ,$$
Rc is a reflectance of a center of the reflection mirror, Rs is a reflectance of an edge of one side of the reflection mirror, δc is a transmittance of a center of the imaging lens, δs is a transmittance of an edge of one side of the imaging lens, and Pr is a component ratio of a P polarized light based on a deflecting surface of the deflector, and
where Pr=1 when only a P polarized light is present based on an incident surface of the deflecting surface of the deflector, and Pr=0 when only an S polarized light is present based on the incident surface of the deflecting surface of the deflector.

9. The image forming apparatus according to claim 8, wherein a wavelength of light generated from the light source is less than about 500 nm.

10. The image forming apparatus according to claim 8, wherein the component ratio Pr is less than about 0.5.

11. The image forming apparatus according to claim 8, wherein the reflection mirror includes aluminum, and TiO₂ and SiO₂ coated in the aluminum.

12. The image forming apparatus according to claim 8, wherein the imaging lens is a plastic material.

13. The image forming apparatus according to claim 8, wherein the reflection mirror is arranged between the deflector and the imaging lens.

14. The image forming apparatus according to claim 8 wherein the reflection mirror is arranged between the imaging lens and the photosensitive body.

15. A light scanning unit to form an electrostatic latent image corresponding to image information on a photosensitive body, comprising:
a light source to generate light having a wavelength less than about 500 nm;
a deflector to deflect light generated from the light source in a main scanning direction;
an imaging lens of a plastic material to focus deflected light to the photosensitive body; and
at least a reflection mirror to change a traveling direction of light,
wherein a reflectance of the reflection mirror satisfies the following equation:
$$\frac{( - δ - 20 \times Pr )}{100} \leq \frac{( Rs - Rc )}{Rc} \leq \frac{( - δ + 20 - 20 \times Pr )}{100} , \\ where$$
$$δ = \frac{δ c - δ c}{δ c} \times 100 ,$$
Rc is a reflectance of a center of the reflection mirror, Rs is a reflectance of an edge of one side of the reflection mirror, δc is a transmittance of a center of the imaging lens, δs is a transmittance of an edge of one side of the imaging lens, and Pr is a component ratio of a P polarized light based on a deflecting surface of the deflector, and
where Pr=1 when only a P polarized light is present based on an incident surface of the deflecting surface of the deflector, and Pr=0 when only an S polarized light is present based on the incident surface of the deflecting surface of the deflector.

16. A light scanning unit to form an electrostatic latent image corresponding to image information on a photosensitive body, comprising:
a light source;
a collimating lens array to collimate light generated from the light source;
a reflection mirror to calibrate a deviation of a light quantity, thereby improving the image quality of images produced by the light scanning unit; and
an imaging lens to focus reflected light to the photosensitive body.

17. The light scanning unit according to claim 16, wherein a wavelength of light generated from the light source is less than about 500 nm.

18. The light scanning unit according to claim 16, wherein the reflection mirror is coated with SiO2 on a base material of aluminum and is further coated with TiO2 thereon.

19. The light scanning unit according to claim 16, wherein a reflectance of the reflection mirror satisfies the following equation:
$$\frac{( - δ - 20 \times Pr )}{100} \leq \frac{( Rs - Rc )}{Rc} \leq \frac{( - δ + 20 - 20 \times Pr )}{100} , \\ where$$
$$δ = \frac{δ s - δ c}{δ c} \times 100 ,$$
Rc indicates a reflectance of light reflected from a center of the reflection mirror, Rs indicates a reflectance of light reflected from an edge of one side of the reflection mirror, δc indicates a transmittance of a center of the imaging lens, δs indicates a transmittance of an edge of one side of the imaging lens, and Pr indicates a component ratio of a polarized light received from the light source.

20. The light scanning unit according to claim 19, wherein the reflection mirror comprises a plurality of reflection mirrors selected according to the equations:
Rc=Rc1×Rc2× . . . Rcn
Rs=Rs1×Rs2× . . . Rsn
where Rc1, Rc2, . . . Rcn indicate a reflectance of light reflected from a center of each of the plurality of reflection mirrors and Rs1, Rs2, . . . Rsn indicate a reflectance of light reflected from an edge of one side of each of the plurality of reflection mirrors.
